(19) United States
(12) Patent Application Publication
(10) Pub. No.: US 2014/0225563 A1
(43) Pub. Date: Aug. 14, 2014

(54) POWER TRANSMITTING DEVICE, VEHICLE, AND POWER TRANSFER SYSTEM

(71) Applicant: TOYOTA JIDOSHA KABUSHIKI KAISHA, Toyota-shi, Aichi-ken (JP)

(72) Inventors: Shinji Ichikawa, Toyota-shi (JP); Toru Nakamura, Toyota-shi (JP); Masaya Ishida, Aichi-gun (JP); Toshiaki Watanabe, Owariasahi-shi (JP); Yasushi Amano, Aichi-gun (JP)

(73) Assignee: TOYOTA JIDOSHA KABUSHIKI KAISHA, Toyota-shi (JP)

(21) Appl. No.: 14/347,477

(22) PCT Filed: Sep. 26, 2012
(86) PCT No.: PCT/IB2012/001900

§ 371 Date: Mar. 26, 2014

(30) Foreign Application Priority Data
Sep. 29, 2011 (JP) 2011-214176

(51) Int. Cl. B60L 11/18; H04B 5/00

(52) U.S. Cl. CPC B60L 11/182; H04B 5/0037
USPC 320/108; 307/104

(57) ABSTRACT

A power transmitting device includes: a power transmitting portion that contactlessly transmits electric power to a power receiving portion spaced apart from the power transmitting portion; a first coil unit that is spaced apart from the power transmitting portion and that supplies electric power to the power transmitting portion; and a supply cable that is connected to the first coil unit and that supplies electric power from a power supply to the first coil unit. The first coil unit includes a first coil connected to the supply cable and a second coil connected to the first coil, and the first coil is arranged around, the power transmitting portion, converts unbalanced current, supplied from the power supply, to balanced current and supplies the balanced current to the second coil.

### BACKGROUND OF THE INVENTION

1. Field of the Invention

The invention relates to a power transmitting device, a vehicle and a power transfer system.

2. Description of Related Art

In recent years, hybrid vehicles, electric vehicles, and the like, that drive driving wheels with the use of electric power from a battery, or the like, become a focus of attention in consideration of an environment.

Particularly, in the above-described electromotive vehicles equipped with a battery, wireless charging through which the battery is contactlessly chargeable without using a plug, or the like, becomes a focus of attention. Various charging systems have been suggested recently, and, particularly, a technique for contactlessly transferring electric power with the use of a resonance phenomenon is put in the spotlight.

For example, a wireless power transfer system described in Japanese Patent Application Publication No. 2010-73976 (JP 2010-73976 A) is one of wireless power transfer systems that use electromagnetic resonance. The wireless power transfer system includes a power supply device having a power supply coil and a power receiving device having a power receiving coil. Electric power is transferred between the power supply coil and the power receiving coil through electromagnetic resonance.

As described in Japanese Patent Application Publication No. 2003-79597 (JP 2003-79597 A), Japanese Patent Application Publication No. 2008-67807 (JP 2008-67807 A) and Japanese Patent Application Publication No. 2004-129689 (JP 2004-129689 A), various magnetic resonance imaging devices have been suggested so far.

In the wireless power transfer system described in JP 2010-73976 A, an electromagnetic induction coil is used to transfer electric power to a power transmitting coil. At the time of transfer of electric power, voltage due to counter-electromotive force through electromagnetic induction is applied to, the electromagnetic induction coil, and current flowing through the electromagnetic induction coil becomes high frequency AC in a balanced state.

If high frequency AC flows through a normal wiring line, the wiring line itself functions as an antenna. As a result, an, electromagnetic wave is formed around the wiring line and the wiring line may become a noise generating source.

In order to prevent the wiring line itself from becoming a noise generating source, it is conceivable that a coaxial cable is employed as the wiring line that connects the electromagnetic induction coil to the power supply.

The coaxial cable includes an inner conductor, an insulator provided so as to cover the outer periphery of the inner conductor and an outer conductor provided on the outer periphery of the insulator. The outer conductor is grounded.

Generally, when the outer conductor of the coaxial cable is grounded, even when current flows through the inner conductor, leakage of magnetic field caused by the current toward the outside is suppressed.

Furthermore, due to surface effect, current flows through the inner surface of the outer conductor, but no current flows through the outer surface of the outer conductor. Thus, radiation of electromagnetic field from the coaxial cable toward the outside is suppressed.

In this way, current flowing inside the electromagnetic induction coil becomes a balanced state; whereas current flowing through the coaxial cable becomes an unbalanced state as described above.

Therefore, when the coaxial cable is simply connected to the electromagnetic induction coil and electric power is supplied from the power supply to a power transmitter, common mode current flows at the outer surface of the outer conductor of the coaxial cable. When common mode current flows, an electromagnetic wave is radiated from the coaxial cable, and becomes a cause of noise.

As a method of suppressing such common mode current, it is conceivable to arrange a balun between the coaxial cable and the transmitter. Generally, a balun includes a ferrite core and a coil wound around the ferrite core.

On the other hand, when high frequency AC flows through the balun, there is a problem that the ferrite core is heated to a high temperature.

The magnetic resonance imaging device described in JP 2003-79597 A, or the like, captures a cross-sectional image of a human body, or the like, with the use of nuclear magnetic resonance. When strong magnetic field is externally applied to hydrogen atoms of water or fat, the energy of an electromagnetic wave is absorbed only by hydrogen atoms, and the energy state of the hydrogen atoms is excited to a higher state. Such a phenomenon is called nuclear magnetic resonance.

Then, when the hydrogen atoms return from the excited energy state to the original energy state, an oscillating magnetic field (electromagnetic wave) occurs around the hydrogen atoms. A period of time (relaxation time) until returning to the original energy state varies on the basis of a tissue and its condition, such as a normal cell and a cancer cell. The magnetic resonance imaging device receives information about the relaxation time and creates an image on the basis of the received information with the use of a computer.

In this way, the magnetic resonance imaging device belongs to a technical field that is totally different from that of a power transfer system that contactlessly transfers electric power.

JP 2003-79597, and the like, do not describe that a coaxial cable or a balun is connected to a transmitter that contactlessly transmits electric power to a power receiver, and do not describe or suggest that, when a balun is connected, a core of the balun is heated to a high temperature.

### SUMMARY OF THE INVENTION

The invention provides a power transmitting device, a vehicle and a power transfer system that are able to reduce noise radiated to an outside and suppress an increase in the temperature of a certain member, even when a coaxial cable is connected to a transmitter.

A first aspect of the invention provides a power transmitting device. The power transmitting device includes: a power transmitting portion that contactlessly transmits electric power to a power receiving portion spaced apart from the power transmitting portion; a first coil unit that is spaced apart from the power transmitting portion and that supplies electric power to the power transmitting portion; and a supply cable that is connected to the first coil unit and that supplies electric power from a power supply to the first coil unit, wherein the first coil unit includes a first coil connected to the supply cable and a second coil connected to the first coil, and the first coil is arranged around the power transmitting portion, converts unbalanced current, supplied from the power supply, to balanced current and supplies the balanced current to the second coil.

The power transmitting portion may include a power transmitting coil, and the power transmitting coil and the first coil may be arranged so as to face each other.

The power transmitting coil and the second coil may be arranged so as to face each other, and a direction in which current flows through the first coil may be different from a direction in which current flows through the second coil. The supply cable may include an inner conductor, an insulator provided so as to cover an outer periphery of the inner conductor, and a grounded outer conductor arranged on the insulator.

The first coil may include a first unit coil, a second unit coil connected to the first unit coil, and a third unit coil connected to the second unit coil. The second coil may include a first end portion and a second end portion. The first unit coil may include a third end portion connected to the inner conductor and a fourth end portion connected to the first end portion. The second unit coil may include a fifth end portion connected to the fourth end portion and a sixth end portion connected to the outer conductor. The third unit coil may include a seventh end portion connected to the sixth end portion and an eighth end portion connected to the second end portion.

The first unit coil, the second unit coil and the third unit coil may be arranged coaxially with one another. The first unit coil, the second unit coil and the third unit coil may have the same shape.

The power transmitting portion may transmit electric power to the power receiving portion through at least one of a magnetic field that is formed between the power receiving portion and the power transmitting portion and that oscillates at a specific frequency and an electric field that is formed between the power receiving portion and the power transmitting portion and that oscillates at the specific frequency. A coupling coefficient between the power receiving portion and the power transmitting portion may be smaller than or equal to 0.1. A difference between a natural frequency of the power transmitting portion and a natural frequency of the power receiving portion may be smaller than or equal to 10% of the natural frequency of the power receiving portion.

A second aspect of the invention provides a vehicle. The vehicle includes: a power receiving portion that contactlessly receives electric power from a power transmitting portion spaced apart from the power receiving portion; a second coil unit that is spaced apart from the power receiving portion and that receives electric power from the power receiving portion; a power receiving cable that is connected to the second coil unit; a converter that is connected to the power receiving cable; and a battery that is connected to the converter, wherein the second coil unit includes a third coil connected to the power receiving cable and a fourth coil connected to the third coil, and the third coil is arranged around the power receiving portion, converts balanced current, supplied from the fourth coil, to unbalanced current, and supplies the unbalanced current to the converter.

The power receiving portion may include a power receiving coil, and the power receiving coil and the third coil may be arranged so as to face each other. The power receiving coil and the fourth coil may be arranged so as to face each other, and a direction in which current flows through the third coil may be different from a direction in which current flows through the fourth coil. The power receiving cable may include an inner conductor, an insulator provided so as to cover an outer periphery of the inner conductor, and an outer conductor arranged on the insulator and grounded.

The third coil may include a fourth unit coil, a fifth unit coil connected to the fourth unit coil, and a sixth unit coil connected to the fifth unit coil. The fourth coil may include a ninth end portion and a tenth end portion. The fourth unit coil may include an eleventh end portion connected to the inner conductor and a twelfth end portion connected to the ninth end portion. The fifth unit coil may include a thirteenth end portion connected to the twelfth end portion and a fourteenth end portion connected to the outer conductor. The sixth unit coil may include a fifteenth end portion connected to the fourteenth end portion and a sixteenth end portion connected to the tenth end portion.

The fourth unit coil, the fifth unit coil and the sixth unit coil may be arranged coaxially with one another. The fourth unit coil, the fifth unit coil and the sixth unit coil may have the same shape.

The power receiving portion may receive electric power from the power transmitting portion through at least one of a magnetic field that is formed between the power receiving portion and the power transmitting portion and that oscillates at a specific frequency and an electric field that is formed between the power receiving portion and the power transmitting portion and that oscillates at the specific frequency. A coupling coefficient between the power receiving portion and the power transmitting portion may be smaller than or equal to 0.1. A difference between a natural frequency of the power transmitting portion and a natural frequency of the power receiving portion may be smaller than or equal to 10% of the natural frequency of the power receiving portion.

A third aspect of the invention provides a power transfer system. The power transfer system includes: a vehicle that includes a power receiving portion; and a power transmitting device that includes a power transmitting portion that contactlessly transmits electric power to the power receiving portion, a first coil unit that is spaced apart from the power transmitting portion and that supplies electric power to the power transmitting portion, and a supply cable that is connected to the first coil unit and that supplies electric power from a power supply to the first coil unit, wherein the first coil unit includes a first coil connected to the supply cable and a second coil connected to the first coil, and the first coil is arranged around the power transmitting portion, converts unbalanced current, supplied from the power supply, to balanced current and supplies the balanced current to the second coil.

A fourth aspect of the invention provides a power transfer system. The power transfer system includes: a power transmitting device that includes a power transmitting portion; and a vehicle that includes a power receiving portion that contactlessly receives electric power from the power transmitting portion, a second coil unit that is spaced apart from the power receiving portion and that receives electric power from the power receiving portion, a power receiving cable that is connected to the second coil unit, a converter that is connected to the power receiving cable, and a battery that is connected to the converter, wherein the second coil unit includes a third coil connected to the power receiving cable and a fourth coil connected to the third coil, and the third coil is arranged around the power receiving portion, converts balanced current, supplied from the fourth coil, to unbalanced current, and supplies the unbalanced current to the converter.

According to the above configurations, it is possible to reduce noise radiated from a coaxial cable, and it is possible to suppress an increase in the temperature of a certain portion.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view that schematically shows a power receiving device, a power transmitting device and a power transfer system according to an embodiment;

FIG. 2 is a view that shows a simulation model of a power transfer system;

FIG. 3 is a graph that shows simulation results;

FIG. 4 is a graph that shows the correlation between a power transfer efficiency and the frequency f of current supplied to a resonance coil at the time when an air gap is changed in a state where a natural frequency is fixed;

FIG. 5 is a graph that shows the correlation between a distance from a current source (magnetic current source) and the strength of an electromagnetic field;

FIG. 6 is a perspective view that schematically shows the configuration of a power transmitting portion 28 and the configuration of a power receiving portion 27;

FIG. 7 is an electrical circuit diagram that shows a coil unit 23, an alternating-current power supply 21, and the like, shown in FIG. 6;

FIG. 8 is an electrical circuit diagram that shows a coil unit 12, a battery 15, and the like;

FIG. 9 is a schematic view that shows an alternative example of the power transmitting portion 28 shown in FIG. 6;

FIG. 10 is a view that shows a power transfer system in which a power transmitting device 41 shown in FIG. 8 is employed;

FIG. 11 is a schematic view that schematically shows a power transfer system according to a comparative embodiment;

FIG. 12 is a graph that shows a power transfer efficiency in the power transfer system according to the comparative embodiment shown in FIG. 11; and

FIG. 13 is a graph that shows a power transfer efficiency in the power transfer system shown in FIG. 10.

### DETAILED DESCRIPTION OF EMBODIMENTS

A power receiving device, a power transmitting device and a power transfer system that includes the power transmitting device and the power receiving device according to an embodiment of the invention will be described with reference to FIG. 1 to FIG. 13. FIG. 1 is a schematic view that schematically shows the power receiving device, the power transmitting device and the power transfer system according to the present embodiment.

The power transfer system according to the present embodiment includes an electromotive vehicle 10 and an external power supply device 20. The electromotive vehicle 10 includes the power receiving device 40. The external power supply device 20 includes the power transmitting device 41. When the electromotive vehicle 10 is stopped at a predetermined position of a parking space 42 in which the power transmitting device 41 is provided, the power receiving device 40 of the electromotive vehicle 10 receives electric power from the power transmitting device 41.

A wheel block or a line is provided in the parking space 42 so that the electromotive vehicle 10 is stopped at a predetermined position.

The external power supply device 20 includes a high-frequency power driver 22, a control unit 26, a power transfer coaxial cable 50 and the power transmitting device 41. The high-frequency power driver 22 is connected to an alternating-current power supply 21. The control unit 26 executes drive control over the high-frequency power driver 22, and the like. The power transfer coaxial cable 50 is connected to the high-frequency power driver 22. The power transmitting device 41 is connected to the power transfer coaxial cable 50. The power transmitting device 41 includes a power transmitting portion 28 and a power transmitting coil unit 23. The power transmitting portion 28 includes a power transmitting resonance coil 24 and a capacitor 25 that is connected to the power transmitting resonance coil 24. The power transmitting coil unit 23 is electrically connected to the high-frequency power driver 22. In the example shown in FIG. 1, the capacitor 25 is provided; however, the capacitor 25 is not necessarily an indispensable component.

The power transmitting portion 28 includes an electrical circuit that is formed of the inductance L of the power transmitting resonance coil 24, the stray capacitance of the power transmitting resonance coil 24 and the capacitance of the capacitor 25.

The electromotive vehicle 10 includes the power receiving device 40, a rectifier 13, a DC/DC converter 14, a battery 15, a power control unit (PCU) 16, a motor unit 17 and a vehicle electronic control unit (ECU) 18. The rectifier 13 is connected to the power receiving device 40. The DC/DC converter 14 is connected to the rectifier 13. The battery 15 is connected to the DC/DC converter 14. The motor unit 17 is connected to the power control unit 16. The vehicle ECU 18 executes drive control over the DC/DC converter 14, the power control unit 16, and the like. The electromotive vehicle 10 according to the present embodiment is a hybrid vehicle that includes an engine (not shown). Instead, the electromotive vehicle 10 just needs to be a vehicle driven by a motor, and includes an electric vehicle and a fuel cell vehicle.

The rectifier 13 is connected to a power receiving coil unit 12, converts alternating current supplied from the power receiving coil unit 12 to direct current, and supplies the direct current to the DC/DC converter 14.

The DC/DC converter 14 adjusts the voltage of the direct current supplied from the rectifier 13, and supplies the adjusted voltage to the battery 15. The DC/DC converter 14 is not an indispensable component and may be omitted. In this case, by providing a matching transformer for matching impedance in the external power supply device 20, it is possible to substitute the matching transformer for the DC/DC converter 14.

The power control unit 16 includes a converter and an inverter. The converter is connected to the battery 15. The inverter is connected to the converter. The converter adjusts (steps up) direct current supplied from the battery 15, and supplies the adjusted direct current to the inverter. The inverter converts the direct current supplied from the converter to alternating current, and supplies the alternating current to the motor unit 17.

For example, a three-phase alternating-current motor, or the like, is employed as the motor unit 17. The motor unit 17 is driven by alternating current supplied from the inverter of the power control unit 16.

When the electromotive vehicle 10 is a hybrid vehicle, the electromotive vehicle 10 further includes an engine and a power split mechanism. In addition, the motor unit 17 includes a motor generator that mainly functions as a generator and a motor generator that mainly functions as an electric motor.

The power receiving device 40 includes a power receiving portion 27 and a power receiving coil unit 12. The power receiving portion 27 includes a power receiving resonance coil 11 and a capacitor 19. The power receiving resonance coil 11 has a stray capacitance. The power receiving portion 27 has an electrical circuit that is formed of the inductance of the power receiving resonance coil 11 and the capacitances of the power receiving resonance coil 11 and capacitor 19.

In the power transfer system according to the present embodiment, the difference between the natural frequency of the power transmitting portion 28 and the natural frequency of the power receiving portion 27 is smaller than or equal to 10% of the natural frequency of the power receiving portion 27 or power transmitting portion 28. By setting the natural frequency of each of the power transmitting portion 28 and the power receiving portion 27 within the above range, it is possible to increase the power transfer efficiency. On the other hand; when the difference in natural frequency becomes larger than 10% of the natural frequency of the power receiving portion 27 or power transmitting portion 28, the power transfer efficiency is lower than 10%, so a charging time for charging the battery 15 extends.

Here, the natural frequency of the power transmitting portion 28, in the case where no capacitor 25 is provided, means an oscillation frequency when the electrical circuit formed of the inductance of the power transmitting resonance coil 24 and the capacitance of the power transmitting resonance coil 24 freely oscillates. In the case where the capacitor 25 is provided, the natural frequency of the power transmitting portion 28 means an oscillation frequency when the electrical circuit formed of the capacitances of the power transmitting resonance coil 24 and capacitor 25 and the inductance of the power transmitting resonance coil 24 freely oscillates. In the above-described electrical circuits, the natural frequency at the time when braking force and electric resistance are set to zero or substantially zero is called the resonance frequency of the power transmitting portion 28.

Similarly, the natural frequency of the power receiving portion 27, in the case where no capacitor 19 is provided, means an oscillation frequency when where the electrical circuit formed of the inductance of the power receiving resonance coil 11 and the capacitance of the power receiving resonance coil 11 freely oscillates. In the case where the capacitor 19 is provided, the natural frequency of the power receiving portion 27 means an oscillation frequency when the electrical circuit formed of the capacitances of the power receiving resonance coil 11 and capacitor 19 and the inductance of the power receiving resonance coil 11 freely oscillates. In the above-described electrical circuits, the natural frequency at the time when braking force and electric resistance are set to zero or substantially zero is called the resonance frequency of the power receiving portion 27.

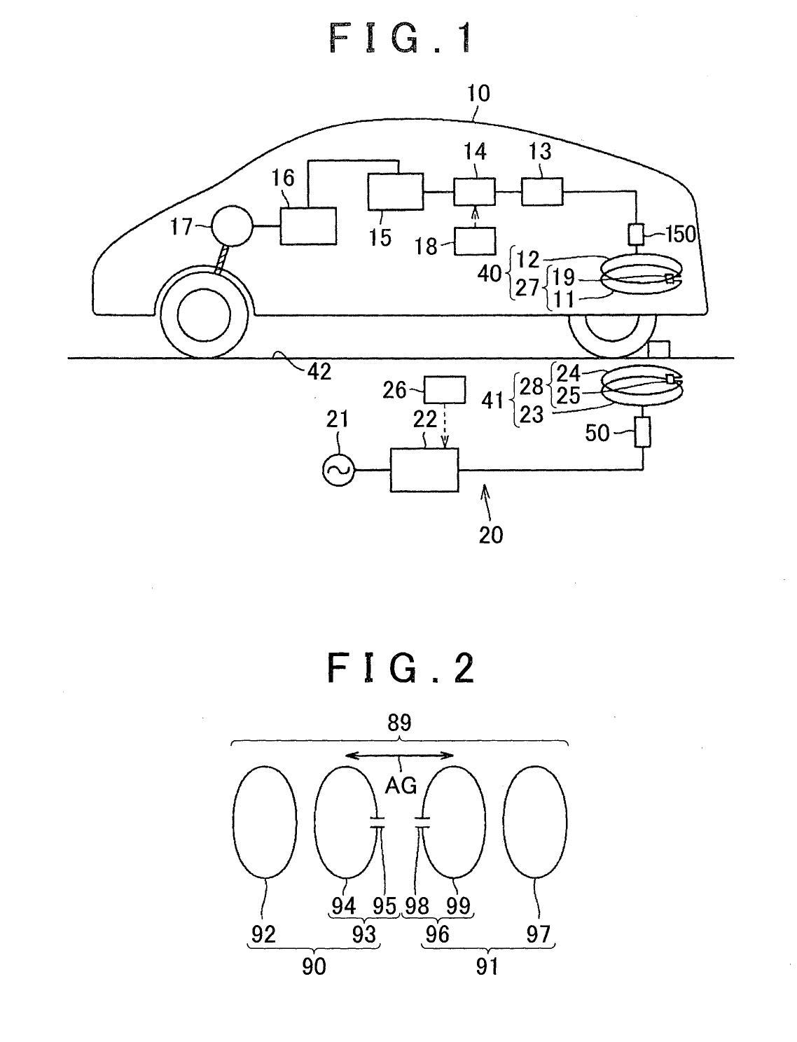

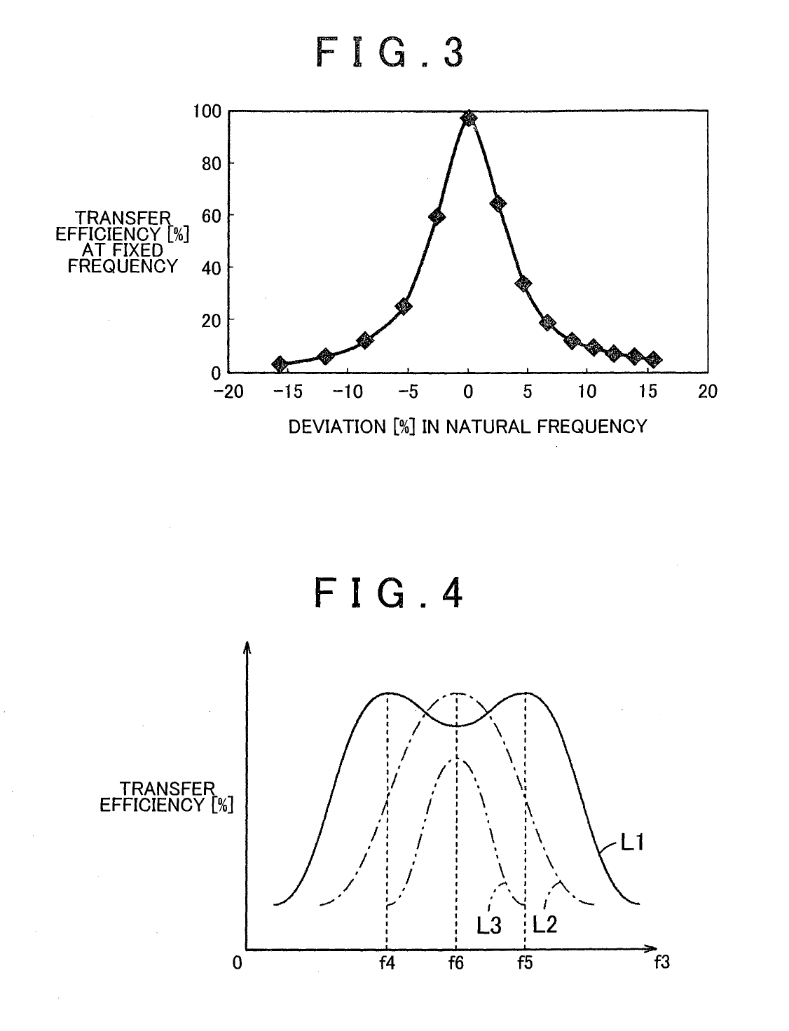

Results of simulation that analyzes the correlation between a difference in natural frequency and a power transfer efficiency will be described with reference to FIG. 2 and FIG. 3. FIG. 2 shows a simulation model of a power transfer system. The power transfer system 89 includes a power transmitting device 90 and a power receiving device 91. The power transmitting device 90 includes an electromagnetic induction coil 92 and a power transmitting portion 93. The power transmitting portion 93 includes a resonance coil 94 and a capacitor 95 provided in the resonance coil 94.

The power receiving device 91 includes a power receiving portion 96 and an electromagnetic induction coil 97. The power receiving portion 96 includes a resonance coil 99 and a capacitor 98 connected to the resonance coil 99.

The inductance of the resonance coil 94 is set to Lt, and the capacitance of the capacitor 95 is set to C1. The inductance of the resonance coil 99 is set to Lr, and the capacitance of the capacitor 98 is set to C2. When the parameters are set in this way, the natural frequency f1 of the power transmitting portion 93 is expressed by the following mathematical expression (1), and the natural frequency f2 of the power receiving portion 96 is expressed by the following mathematical expression (2).

f1=1/{2π(Lt×C1)^{1/2}} (1)

f2=1/{2π(Lt×C2)^{1/2}} (2)

Here, in the case where the inductance Lr and the capacitances C1 and C2 are fixed and only the inductance Lt is varied, the correlation between a difference in natural frequency between the power transmitting portion 93 and the power receiving portion 96 and a power transfer efficiency is shown in FIG. 3. Note that, in this simulation, a relative positional relationship between the resonance coil 94 and the resonance coil 99 is fixed, and, furthermore, the frequency of current supplied to the power transmitting portion 93 is constant.

As shown in FIG. 3, the abscissa axis represents a difference Df (%) in natural frequency, and the ordinate axis represents a transfer efficiency (%) at a fixed frequency. The difference Df (%) in natural frequency is expressed by the following mathematical expression (3).

Df={(f1−f2)/f2}×100 (3)

As is apparent from FIG. 3, when the difference (%) in natural frequency is ±0%, the power transfer efficiency is close to 100%. When the difference (%) in natural frequency is ±5%, the power transfer efficiency is 40%. When the difference (%) in natural frequency is ±10%, the power transfer efficiency is 10%. When the difference (%) in natural frequency is ±15%, the power transfer efficiency is 5%. That is, it is found that, by setting the natural frequency of each of the power transmitting portion and power receiving portion such that the absolute value of the difference (%) in natural frequency (difference in natural frequency) falls at or below 10% of the natural frequency of the power receiving portion 96, it is possible to increase the power transfer efficiency. Furthermore, it is found that, by setting the natural frequency of each of the power transmitting portion and power receiving portion such that the absolute value of the difference (%) in natural frequency is smaller than or equal to 5% of the natural frequency of the power receiving portion 96, it is possible to further increase the power transfer efficiency. Note that the electromagnetic field analyzation software application (JMAG (registered trademark): produced by JSOL Corporation) is employed as a simulation software application.

Next, the operation of the power transfer system according to the present embodiment will be described. Alternating-current power is supplied from the high-frequency power driver 22 to the power transmitting coil unit 23. When a predetermined alternating current flows through the power transmitting coil unit 23, alternating current also flows through the power transmitting resonance coil 24 due to electromagnetic induction. At this time, electric power is supplied to the power transmitting coil unit 23 such that the frequency of alternating current flowing through the power transmitting resonance coil 24 becomes a specific frequency.

When current having the specific frequency flows through the power transmitting resonance coil 24, an electromagnetic field that oscillates at the specific frequency is formed around the power transmitting resonance coil 24.

The power receiving resonance coil 11 is arranged within a predetermined range from the power transmitting resonance coil 24. The power receiving resonance coil 11 receives electric power from the electromagnetic field formed around the power transmitting resonance coil 24.

In the present embodiment, a so-called helical coil is employed as each of the power receiving resonance coil 11 and the power transmitting resonance coil 24. Therefore, a magnetic field that oscillates at the specific frequency is mainly formed around the power receiving resonance coil 11, and the power transmitting resonance coil 24 receives electric power from the magnetic field.

Here, the magnetic field having the specific frequency, formed around the power transmitting resonance coil 24, will be described. The “magnetic field having the specific frequency” typically correlates with the power transfer efficiency and the frequency of current supplied to the power transmitting resonance coil 24. First, the correlation between the power transfer efficiency and the frequency of current supplied to the power transmitting resonance coil 24 will be described. The power transfer efficiency at the time when electric power is transferred from the power transmitting resonance coil 24 to the power receiving resonance coil 11 varies depending on various factors, such as a distance between the power transmitting resonance coil 24 and the power receiving resonance coil 11. For example, the natural frequency (resonance frequency) of the power transmitting portion 28 and power receiving portion 27 is set to f0, the frequency of current supplied to the power transmitting resonance coil 24 is f3, and the air gap between the power receiving resonance coil 11 and the power transmitting resonance coil 24 is set to AG.

FIG. 4 is a graph that shows the correlation between a power transfer efficiency and the frequency f3 of current supplied to the power transmitting resonance coil 24 at the time when the air gap AG is varied in a state where the natural frequency f0 is fixed.

In the graph shown in FIG. 4, the abscissa axis represents the frequency f3 of current supplied to the power transmitting resonance coil 24, and the ordinate axis represents a power transfer efficiency (%). An efficiency curve L1 schematically shows the correlation between a power transfer efficiency and the frequency f3 of current supplied to the power transmitting resonance coil 24 when the air gap AG is small. As indicated by the efficiency curve L1, when the air gap AG is small, the peak of the power transfer efficiency appears at frequencies f4 and f5 (f4<f5). When the air gap AG is increased, two peaks at which the power transfer efficiency is high vary so as to approach each other. Then, as indicated by an efficiency curve L2, when the air gap AG is increased to be longer than a predetermined distance, the number of the peaks of the power transfer efficiency is one, the power transfer efficiency becomes a peak when the frequency of current supplied to the resonance coil 24 is f6. When the air gap AG is further increased from the state of the efficiency curve L2, the peak of the power transfer efficiency reduces as indicated by an efficiency curve L3.

For example, the following first and second methods are conceivable as a method of improving the power transfer efficiency. In the first method, by varying the capacitances of the capacitor 25 and capacitor 19 in accordance with the air gap AG while the frequency of current supplied to the power transmitting resonance coil 24 shown in FIG. 1 is constant, the characteristic of power transfer efficiency between the power transmitting portion 28 and the power receiving portion 27 is varied. Specifically, the capacitances of the capacitor 25 and capacitor 19 are adjusted such that the power transfer efficiency becomes a peak in a state where the frequency of current supplied to the power transmitting resonance coil 24 is constant. In this method, irrespective of the size of the air gap AG, the frequency of current flowing through the power transmitting resonance coil 24 and the power receiving resonance coil 11 is constant. As a method of varying the characteristic of power transfer efficiency, a method of utilizing a matching transformer provided between the power transmitting device 41 and the high-frequency power driver 22, a method of utilizing the converter 14, or the like, may be employed.

In addition, in the second method, the frequency of current supplied to the resonance coil 24 is adjusted on the basis of the size of the air gap AG. For example, in FIG. 4, when the power transfer characteristic becomes the efficiency curve L1, current having the frequency f4 or the frequency f5 is supplied to the power transmitting resonance coil 24. When the frequency characteristic becomes the efficiency curve L2 or L3, current having the frequency f6 is supplied to the power transmitting resonance coil 24. In this case, the frequency of current flowing through the power transmitting resonance coil 24 and the power receiving resonance coil 11 is varied in accordance with the size of the air gap AG.

In the first method, the frequency of current flowing through the power transmitting resonance coil 24 is a fixed constant frequency, and, in the second method, the frequency of current flowing through the power transmitting resonance coil 24 is a frequency that appropriately varies with the air gap AG. Through the first method, the second method, or the like, current having the specific frequency set such that the power transfer efficiency is high is supplied to the power transmitting resonance coil 24. When current having the specific frequency flows through the power transmitting resonance coil 24, a magnetic field (electromagnetic field) that oscillates at the specific frequency is formed around the power transmitting resonance coil 24. The power receiving portion 27 receives electric power from the power transmitting portion 28 through the magnetic field that is formed between the power receiving portion 27 and the power transmitting portion 28 and that oscillates at the specific frequency. Thus, the “magnetic field that oscillates at the specific frequency” is not necessarily a magnetic field having a fixed frequency. Note that, in the above-described embodiment, the frequency of current supplied to the power transmitting resonance coil 24 is set on the basis of the air gap AG; however, the power transfer efficiency also varies on the basis of other factors, such as a deviation in the horizontal position between the power transmitting resonance coil 24 and the power receiving resonance coil 11, so the frequency of current supplied to the power transmitting resonance coil 24 may possibly be adjusted on the basis of those other factors.

In the present embodiment, the description is made on the example in which a helical coil is employed as each resonance coil; however, when a meander line antenna, or the like, is employed as each resonance coil, current having the specific frequency flows through the power transmitting resonance coil 24, and, therefore, an electric field having the specific frequency is formed around the power transmitting resonance coil 24. Then, through the electric field, power is transferred between the power transmitting portion 28 and the power receiving portion 27.

In the power transfer system according to the present embodiment, a near field (evanescent field) in which the electrostatic field of an electromagnetic field is dominant is utilized. By so doing, power transmitting and power receiving efficiencies are improved.

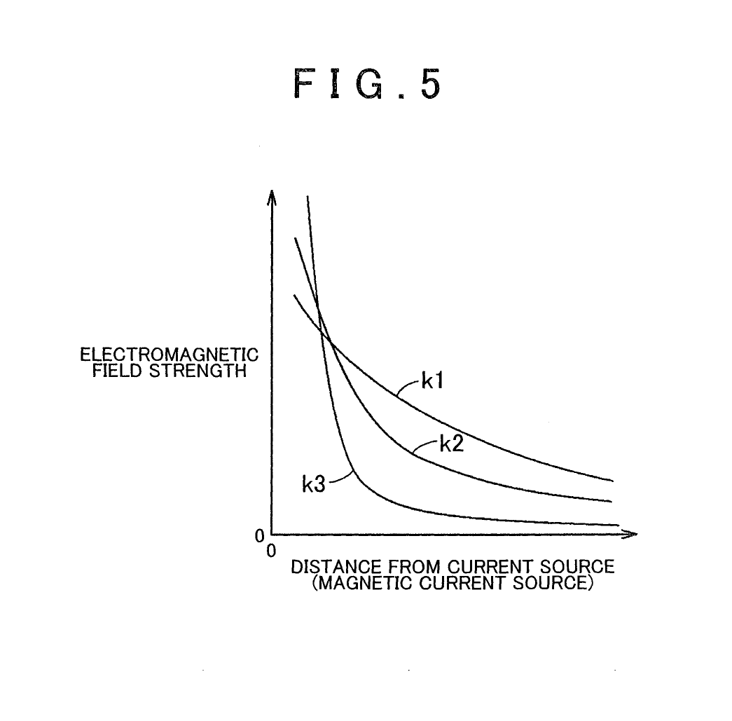

FIG. 5 is a graph that shows the correlation between a distance from a current source (magnetic current source) and the strength of an electromagnetic field. As shown in FIG. 5, the electromagnetic field includes three components. A curve k1 is a component inversely proportional to a distance from a wave source, and is referred to as radiation field. A curve k2 is a component inversely proportional to the square of a distance from a wave source, and is referred to as induction field. In addition, a curve k3 is a component inversely proportional to the cube of a distance from a wave source, and is referred to as electrostatic field. Where the wavelength of the electromagnetic field is λ, a distance at which the strengths of the radiation field, induction field and electrostatic field are substantially equal to one another may be expressed as λ/2π.

The electrostatic field is a region in which the strength of electromagnetic wave steeply reduces with an increase in distance from a wave source. In the power transfer system according to the present embodiment, transfer of energy (electric power) is performed by utilizing the near field (evanescent field) in which the electrostatic field is dominant. That is, by resonating the power transmitting portion 28 and the power receiving portion 27 (for example, a pair of LC resonance coils) having the same natural frequency in the near field in which the electrostatic field is dominant, energy (electric power) is transferred from the power transmitting portion 28 to the power receiving portion 27. This electrostatic field does not propagate energy to a far place. Thus, in comparison with an electromagnetic wave that transfers energy (electric power) by the radiation field that propagates energy to a far place, the resonance method is able to transmit electric power with a less energy loss.

In this way, in the power transfer system according to the present embodiment, by resonating the power transmitting portion 28 and the power receiving portion 27 through the electromagnetic field, electric power is transmitted from the power transmitting device 41 to the power receiving device 40. A coupling coefficient κ between the power transmitting portion 28 and the power receiving portion 27 is smaller than or equal to 0.1. Generally, in power transfer that utilizes electromagnetic induction, the coupling coefficient κ between the power transmitting portion and the power receiving portion is close to 1.0.

Coupling between the power transmitting portion 28 and the power receiving portion 27 in power transfer according to the present embodiment is called “magnetic resonance coupling”, “magnetic field resonance coupling”, “electromagnetic field resonance coupling” or “electric field resonance coupling”.

The electromagnetic field resonance coupling means coupling that includes the magnetic resonance coupling, the magnetic field resonance coupling and the electric field resonance coupling.

Coil-shaped antennas are employed as the power transmitting resonance coil 24 of the power transmitting portion 28 and the power receiving resonance coil 11 of the power receiving portion 27, described in the specification. Therefore, the power transmitting portion 28 and the power receiving portion 27 are mainly coupled through a magnetic field, and the power transmitting portion 28 and the power receiving portion 27 are coupled through magnetic resonance or magnetic field resonance.

An antenna, such as a meander line antenna, may be employed as each resonance coil. In this case, the power transmitting portion 28 and the power receiving portion 27 are mainly coupled through an electric field. At this time, the power transmitting portion 28 and the power receiving portion 27 are coupled through electric field resonance.

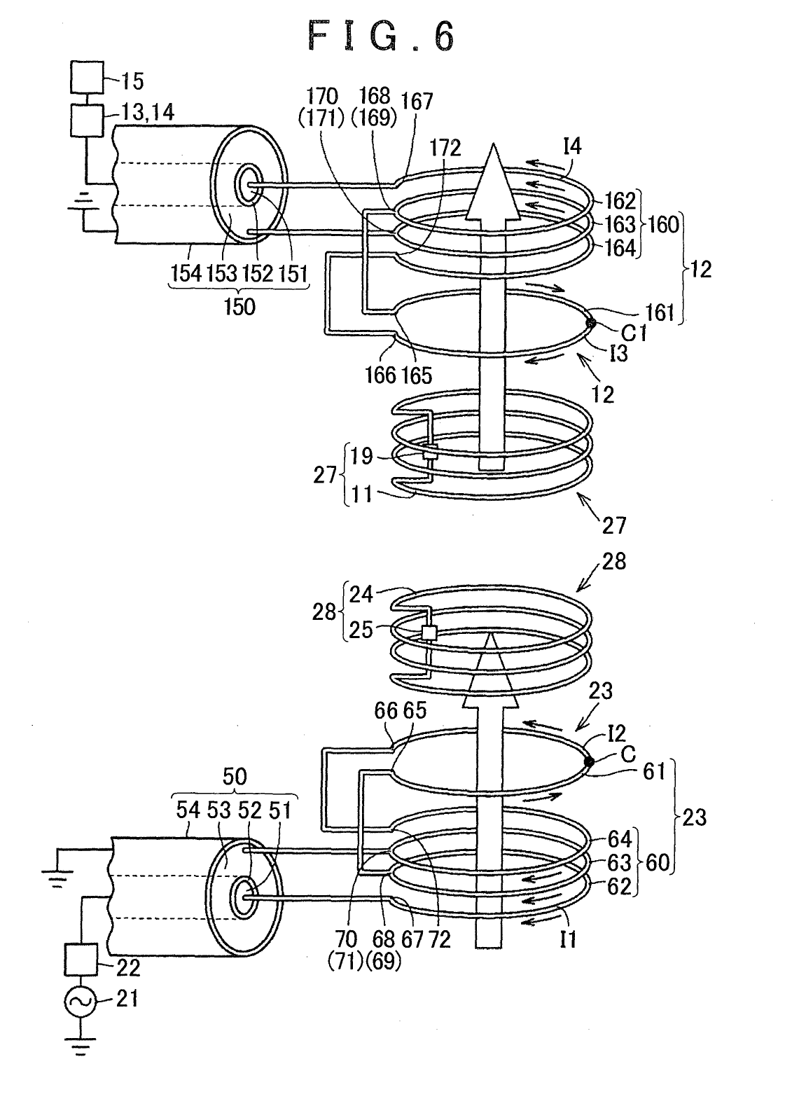

FIG. 6 is a perspective view that schematically shows the configuration of the power transmitting portion 28 and the configuration of the power receiving portion 27. As shown in FIG. 6, the power transfer coaxial cable 50 is connected to the power transmitting coil unit 23 of the power transmitting portion 28. The power transfer coaxial cable 50 includes an inner conductor 51, an insulator 52, an outer conductor 53 and a protective sheath 54. The insulator 52 covers the outer periphery of the inner conductor 51. The outer conductor 53 is formed to cover the outer periphery of the insulator 52. The protective sheath 54 is formed to cover the outer periphery of the outer conductor 53. The inner conductor 51 is connected to the high-frequency power driver 22. The outer conductor 53 is grounded. Therefore, the potential of the outer conductor 53 is 0 V. On the other hand, for example, a voltage of 0 (V) to Vt (V) (Vt: positive value) is applied to the inner conductor 51.

The power transmitting coil unit 23 is arranged around the power transmitting resonance coil 24. The power transmitting coil unit 23 includes a first power transmitting coil 60 and a second power transmitting coil 61. The first power transmitting coil 60 is formed by winding coil wires in multiple turns. The second power transmitting coil 61 is connected to the first power transmitting coil 60. The first power transmitting coil 60 includes a unit coil 62, a unit coil 63 connected to the unit coil 62, and a unit coil 64 connected to the unit coil 63.

The number of turns of the unit coil 62, the number of turns of the unit coil 63 and the number of turns of the unit coil 64 each are one. Thus, the number of turns of each unit coil is the same. The unit coil 62, the unit coil 63 and the unit coil 64 all are arranged coaxially with one another. In addition, the winding diameter of each of the unit coil 62, unit coil 63 and unit coil 64 is the same. That is, the unit coil 62, the unit coil 63 and the unit coil 64 each have the same shape. Therefore, a magnetic flux that passes through the unit coils 62 to 64 is common.

The second power transmitting coil 61 is formed in substantially one turn in the example shown in FIG. 6. The second power transmitting coil 61 includes an end portion 65 and an end portion 66. The unit coil 62 includes an end portion 67 and an end portion 68. The end portion 67 is connected to the inner conductor 51 of the power transfer coaxial cable 50. The end portion 68 is connected to the end portion 65 of the coil 61.

The unit coil 63 includes an end portion 69 and an end portion 70. The end portion 69 is connected to the end portion 68 of the unit coil 62. The end portion 70 is connected to the outer conductor 53 of the power transfer coaxial cable 50. The unit coil 64 includes an end portion 71 and an end portion 72. The end portion 71 is connected to the end portion 70 of the unit coil 63. The end portion 72 is connected to the end portion 66 of the coil 61.

A power receiving coaxial cable 150 is connected to the power receiving coil unit 12 of the power receiving portion 27. The power receiving coaxial cable 150 includes an inner conductor 151, an insulator 152, an outer conductor 153 and a protective sheath 154. The insulator 152 covers the outer periphery of the inner conductor 151. The outer conductor 153 is formed to cover the outer periphery of the insulator 152. The protective sheath 154 is formed to cover the outer periphery of the outer conductor 153. The inner conductor 151 is connected to the rectifier 13. The outer conductor 153 is grounded. Therefore, the potential of the outer conductor 153 is 0 V.

The power receiving coil unit 12 is arranged around the power receiving resonance coil 11. The power receiving coil unit 12 includes a first power receiving coil 160 and a second power receiving coil 161. The first power receiving coil 160 is formed by winding coil wires in multiple turns. The second power receiving coil 161 is connected to the first power receiving coil 160. The first power receiving coil 160 includes a unit coil 162, a unit coil 163 connected to the unit coil 162, and a unit coil 164 connected to the unit coil 163.

The number of turns of the unit coil 162, the number of turns of the unit coil 163 and the number of turns of the unit coil 164 each are one. Thus, the number of turns of each unit coil is the same. The unit coil 162, the unit coil 163 and the unit coil 164 all are arranged coaxially with one another. In addition, the winding diameter of each of the unit coil 162, unit coil 163 and unit coil 164 is the same. That is, the unit coil 162, the unit coil 163 and the unit coil 164 each have the same shape.

The second power receiving coil 161 is formed in substantially one turn in the example shown in FIG. 6. The second power receiving coil 161 includes an end portion 165 and an end portion 166. The unit coil 162 includes an end portion 167 and an end portion 168. The end portion 167 is connected to the inner conductor 151 of the power receiving coaxial cable 150. The end portion 168 is connected to the end portion 165 of the coil 161.

The unit coil 163 includes an end portion 169 and an end portion 170. The end portion 169 is connected to the end portion 168 of the unit coil 162. The end portion 170 is connected to the outer conductor 153 of the power receiving coaxial cable 150. The unit coil 164 includes an end portion 171 and an end portion 172. The end portion 171 is connected to the end portion 170 of the unit coil 163. The end portion 172 is connected to the end portion 166 of the coil 161.

Currents, flowing through the coils, and the like when electric power is transferred with the use of the thus configured power transmitting portion 28 and power receiving portion 27 will be described.

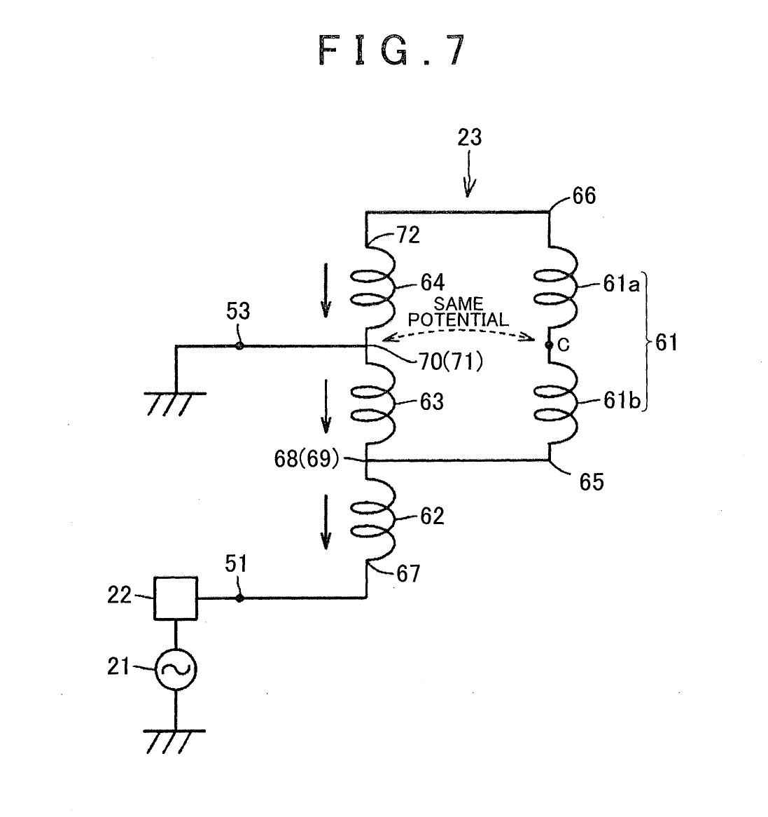

FIG. 7 is an electrical circuit diagram that shows the power transmitting coil unit 23, the alternating-current power supply 21, and the like, shown in FIG. 6. Here, when alternating current is supplied from the alternating-current power supply 21 to the first power transmitting coil 60, induced electromotive force occurs in the first power transmitting coil 60 through electromagnetic induction, and the potentials of the unit coils 62 to 64 fluctuate within a predetermined range.

Fluctuations in the potentials of the unit coils 62 to 64 will be described. In FIG. 7 and FIG. 6, for example, when an unbalanced current having a voltage of 0 (V) to Vt (V) is supplied from the alternating-current power supply 21 to the power transmitting coil unit 23, the voltage between the end portion 67 of the unit coil 62 and the end portion 70 of the unit coil 63 fluctuates within the range of 0 (V) to Vt (V).

Furthermore, the unit coil 63 and the unit coil 64 are arranged coaxially with each other, and the number of turns of the unit coil 63 coincides with the number of turns of the unit coil 64. Therefore, a potential difference that occurs between the end portion 70 and end portion 69 of the unit coil 63 is equal to a potential difference that occurs between the end portion 71 and end portion 72 of the unit coil 64.

The end portion 71 of the unit coil 64 is grounded, so the voltage between the end portion 71 and end portion 72 of the unit coil 64 fluctuates within the range of −Vt/2 (V) to 0 (V).

The end portion 66 of the second power transmitting coil 61 is connected to the end portion 72, and the end portion 65 is connected to the end portion 69, so alternating current of which the voltage oscillates within the range of −Vt/2 (V) to Vt/2 (V) flows through the second power transmitting coil 61.

In FIG. 7, the second power transmitting coil 61 is schematically divided at the center portion into two coils 61a and 61b. When the longitudinal center portion of the second power transmitting coil 61 is referred to as a center portion C, the potential of the center portion C becomes 0 (V). In this way, the first power transmitting coil 60 converts unbalanced current from the alternating-current power supply 21 to balanced current and supplies the balanced current to the second power transmitting coil 61.

On the other hand, when the unit coil 62 and the unit coil 63 are regarded as an integrated coil, the voltage of −Vt (V) to Vt (V) is applied to the end portion 67 of the integrated coil, and the potential of the other end portion 70 is 0 (V). Therefore, unbalanced current flows through the integrated coil formed of the unit coil 62 and the unit coil 63, and the power transfer coaxial cable 50 is connected to the integrated coil, so common mode current is prevented from flowing through the outer conductor 53.

In this way, common mode current is prevented from flowing through the outer conductor 53 of the power transfer coaxial cable 50, so radiation of noise from the power transfer coaxial cable 50 toward an outside is suppressed.

In FIG. 6, a multilayer coil is employed as the power transmitting portion 28. The first power transmitting coil 60 is arranged around the power transmitting portion 28. At the time of transfer of electric power, an evanescent field (near field) is formed around the power transmitting portion 28.

Here, the potentials of the unit coils 62 to 64 depend on an induced electromotive force, and the induced electromotive force depends on the amount of magnetic flux that passes through the first power transmitting coil 60.

In the present embodiment, the first power transmitting coil 60 is arranged around the power transmitting portion 28, so many magnetic lines of force tend to be supplied from the evanescent field having high energy.

Therefore, with fluctuations in potential supplied from the alternating-current power supply 21, a large amount of magnetic lines of force pass through the first power transmitting coil 60, and an induced electromotive force is appropriately generated in the first power transmitting coil 60. Particularly, the first power transmitting coil 60 and the power transmitting resonance coil 24 are arranged coaxially with each other such that the winding center line of the first power transmitting coil 60 coincides with the winding center line of the power transmitting resonance coil 24 of the power transmitting device 41, and the first power transmitting coil 60 and the power transmitting resonance coil 24 are arranged so as to face each other. Therefore, magnetic flux is appropriately supplied from the evanescent field, formed around the power transmitting device 41, to the first power transmitting coil 60.

Therefore, even in a state where a ferrite core is not inserted in the first power transmitting coil 60, it is possible to generate induced electromotive force in the first power transmitting coil 60, so it is possible to omit a ferrite core. Accordingly, an inconvenience, such as an increase in the temperature of a ferrite core, does not occur.

In this way, when an induced electromotive force occurs in the first power transmitting coil 60, current I1 flows through the first power transmitting coil 60. The second power transmitting coil 61 is connected to the first power transmitting coil 60, and current I2 flows through the second power transmitting coil 61. In the present embodiment, the power transmitting resonance coil 24, the second power transmitting coil 61 and the first power transmitting coil 60 are arranged coaxially with one another such that the second power transmitting coil 61 and the first power transmitting coil 60 face each other and the second power transmitting coil 61 and the power transmitting resonance coil 24 face each other. Here, in FIG. 6, a positive potential is applied to the end portion 65 of the second power transmitting coil 61, and a negative potential is applied to the end portion 66, so the direction in which the current I2 flows is opposite to the direction in which the current I1 flows.

Therefore, the direction of magnetic lines of force radiated from the second power transmitting coil 61 is opposite to the direction of magnetic lines of force radiated from the first power transmitting coil 60. Thus, the amount of magnetic flux radiated from the power transmitting coil unit 23 toward the power transmitting resonance coil 24 is obtained by subtracting the amount of magnetic flux, from the second power transmitting coil 61 from the amount of magnetic flux from the first power transmitting coil 60.

In other words, by adjusting the number of turns of the second power transmitting coil 61, it is possible to adjust the amount of magnetic flux supplied to the power transmitting portion 28, and it is possible to adjust the impedance of the power transmitting side.

By so doing, it is possible to match the impedance of the power receiving-side vehicle with the impedance of the power transmitting side, so it is possible to increase transfer efficiency at the time when electric power is transferred from the power transmitting device 41 to the power receiving device 40.

In FIG. 6, fluctuations in magnetic flux radiated from the power transmitting coil unit 23 toward the power transmitting resonance coil 24 depend on the frequency of current supplied to the power transmitting coil unit 23. The magnetic flux radiated from the power transmitting coil unit 23 toward the power transmitting resonance coil 24 varies, and thereby an induced electromotive force occurs in the power transmitting resonance coil 24. By so doing, alternating, current flows through the power transmitting resonance coil 24. At this time, the frequency of alternating current flowing through the power transmitting resonance coil 24 is the predetermined frequency at which the power transfer efficiency is high.

In this way, alternating current having the specific frequency flows through the power transmitting resonance coil 24, and a magnetic field having the specific frequency is formed around the power transmitting resonance coil 24. Then, the power receiving portion 27 (power receiving resonance coil 11) receives electric power from the magnetic field. Alternating current having the specific frequency flows through the power receiving resonance coil 11.

When alternating current flows through the power receiving resonance coil 11, magnetic flux flowing from the power receiving resonance coil 11 toward the power receiving coil unit 12 varies. By so doing, current flows through each of the coils 161 to 164.

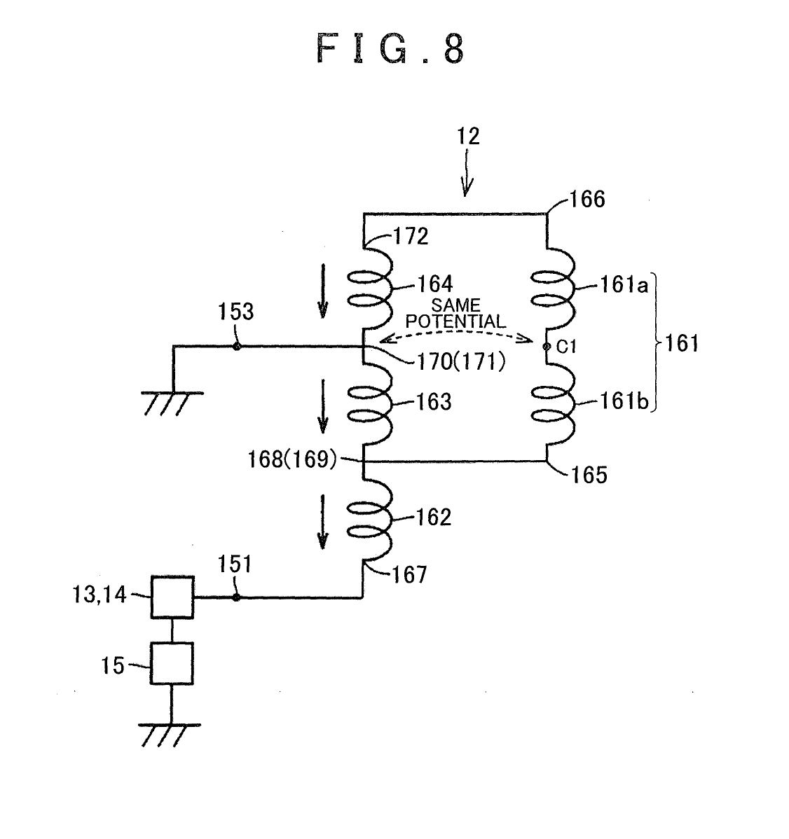

FIG. 8 is an electrical circuit diagram that shows the power receiving coil unit 12, the battery 15, and the like. In FIG. 8, the longitudinal center portion of the second power receiving coil 161 is referred to as a center portion C1. In FIG. 8, the second power receiving coil 161 is schematically divided at the center portion C1 into a coil 161a and a coil 161b.

An induced electromotive force occurs in the second power receiving coil 161 due to a variation in magnetic flux from the power receiving resonance coil 11. Current flowing through the second power receiving coil 161 due to the induced electromotive force is a balanced current. In addition, a voltage within the range of −Vr (V) to Vr (V) is applied between the end portion 166 and the end portion 165. The potential of the center portion C1 is 0 V.

Here, the unit coil 164 and the unit coil 163 are connected to the second power receiving coil 161 in parallel with each other, so a voltage within the range of −Vr (V) to Vr (V) is applied between the end portion 172 of the unit coil 164 and the end portion 169 of the unit coil 163.

The unit coil 163 and the unit coil 164 have the same coil shape, so voltages respectively applied to the unit coils are equal to each other. The end portion 170 of the unit coil 163 is grounded, so the potential difference between the end portion 170 and end portion 169 of the unit coil 163 is Vr (V).

Here, the unit coil 162 and the unit coil 163 are the same coil, so the potential difference between the end portion 168 and end portion 167 of the unit coil 162 is also Vr (V).

The potential of the end portion 170 of the unit coil 163 is 0 V. Therefore, when the unit coil 162 and the unit coil 163 are regarded as an integrated coil, an unbalanced current having 0 (V) to 2Vr (V) flows through the integrated coil.

Then, the unbalanced current is supplied to the rectifier 13 and the converter 14. The rectifier 13 converts unbalanced electric power to direct-current power, and charges the battery 15. The potential of the outer conductor 153 is 0 (V), so common mode current is prevented from flowing through the outer conductor 153. Therefore, occurrence of noise from the power receiving coaxial cable 150 shown in FIG. 6 is also suppressed.

In FIG. 6, the first power receiving coil 160 is arranged around the power receiving portion 27. At the time of transfer of electric power, an evanescent field having high energy is also formed around the power receiving portion 27. The first power receiving coil 160 is arranged around the power receiving portion 27, so magnetic flux is appropriately supplied from the evanescent field. By so doing, each of the unit coil 162 to the unit coil 164 functions as a balun by which the first power receiving coil 160 converts balanced current to unbalanced current. Therefore, in the first power receiving coil 160 as well, a ferrite core may be omitted.

Furthermore, the second power receiving coil 161 and the first power receiving coil 160 are arranged so as, to face each other. By so doing, for example, by adjusting the number of turns, or the like, of the second power receiving coil 161, it is possible to adjust the impedance of the power receiving portion 27 side. By so doing, it is possible to match the vehicle-side impedance with the power transmitting-side impedance.

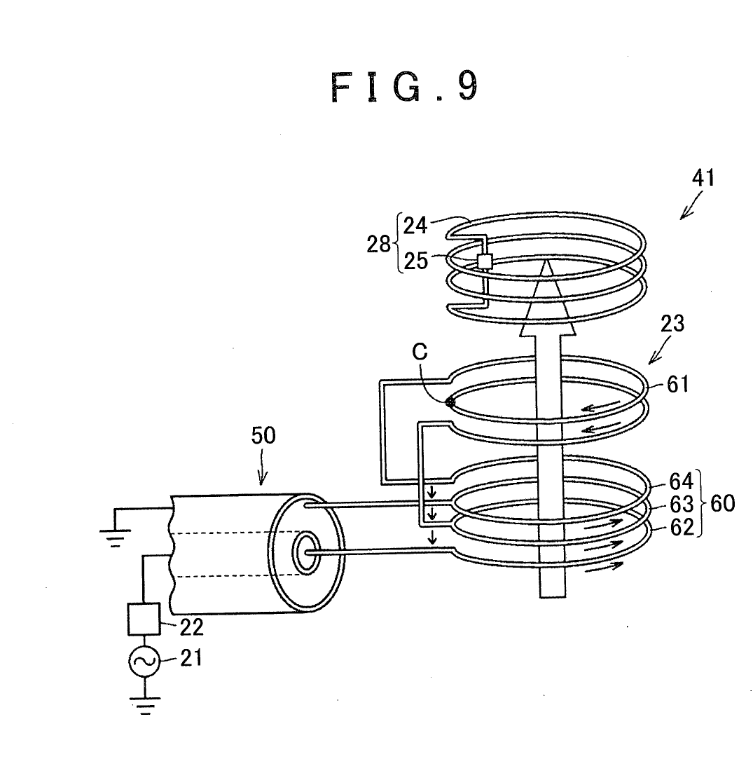

FIG. 9 is a schematic view that shows an alternative example of the power transmitting portion 28 shown in FIG. 6. In the example shown in FIG. 9, the second power transmitting coil 61 is formed in about two turns. By so doing, the amount of magnetic flux supplied from the power transmitting coil unit 23 to the power transmitting portion 28 varies from the amount of magnetic flux supplied from the power transmitting coil unit 23, shown in FIG. 6, to the power transmitting portion 28.

In the example shown in FIG. 9, the power transmitting-side impedance is varied by changing the number of turns of the second power transmitting coil 61; instead, it is also possible to adjust the power transmitting-side impedance by setting the integral multiple of the number of turns of the first power transmitting coil 60 shown in FIG. 6 and the integral multiple of the number of turns of the second power transmitting coil 61 shown in FIG. 6.

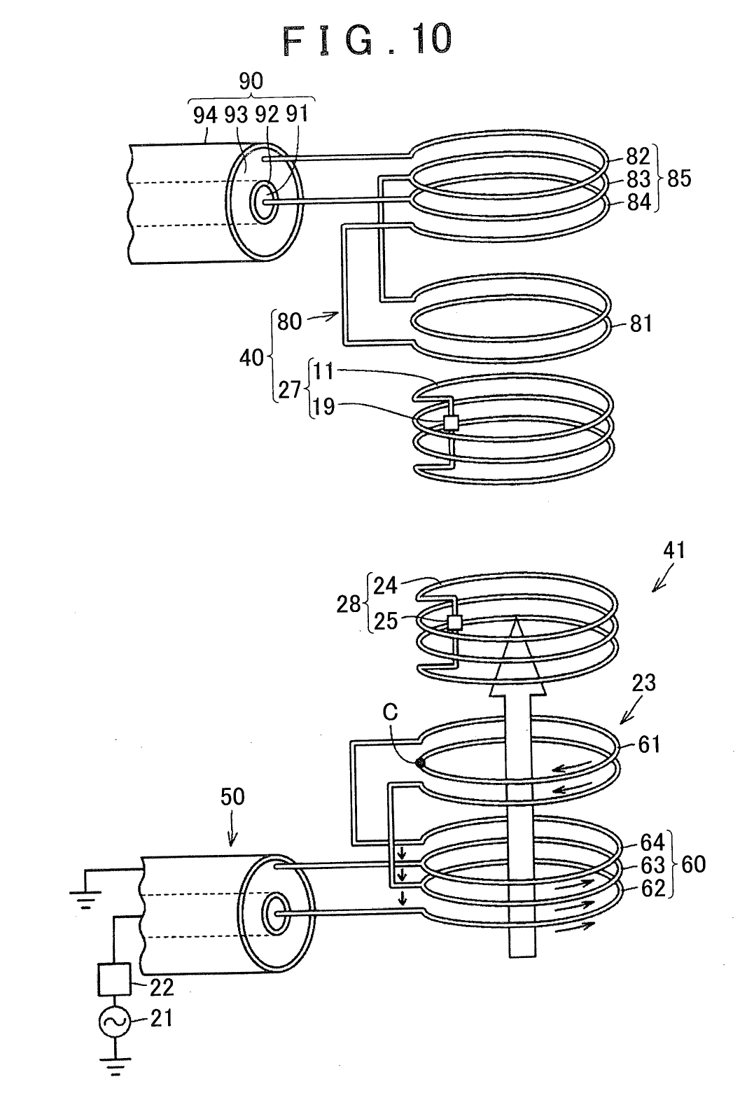

FIG. 10 shows a power transfer system in which the power transmitting device 41 shown in FIG. 8 is employed. The power transfer system shown in FIG. 10 includes the power transmitting device 41 and the power receiving device 40. The power transmitting device 41 includes the power transmitting portion 28 and the power transmitting coil unit 23. The power receiving device 40 substantially has the same configuration as that of the power transmitting device 41. A power receiving coaxial cable 90 is connected to the power receiving device 40, and the power receiving device 40 includes a power receiving coil unit 80 and the power receiving portion 27.

The power receiving coaxial cable 90 includes an inner conductor 91, an insulator 92, an outer conductor 93 and a protective sheath 94. The insulator 92 is formed to cover the outer periphery of the inner conductor 91. The outer conductor 93 is formed on the outer periphery of the insulator 92. The protective sheath 94 covers the outer periphery of the outer conductor 93.

The power receiving portion 27 includes the power receiving resonance coil 11 and the capacitor 19. The power receiving resonance coil 11 is wound in multiple turns. The capacitor 19 is connected to both end portions of the power receiving resonance coil 11. The natural frequency of the power receiving portion 27 coincides with the natural frequency of the power transmitting portion 28.

The power receiving coil unit 80 includes a second power receiving coil 81 and a first power receiving coil 85. The first power receiving coil 85 is connected to the second power receiving coil 81 and the power receiving coaxial cable 90. The number of turns of the second power receiving coil 81 is also substantially two as in the case of the second power transmitting coil 61.

The first power receiving coil 85 has substantially the same configuration as the first power transmitting coil 60. Specifically, the first power receiving coil 85 includes a unit coil 82, a unit coil 83 and a unit coil 84. One end of the unit coil 82 is connected to the outer conductor 93, and the other end of the unit coil 82 is connected to one end portion of the second power receiving coil 81. One end portion of the unit coil 83 is connected to a connecting portion between the unit coil 82 and the second power receiving coil 81.

The inner conductor 91 is connected to the other end portion of the unit coil 83. One end portion of the unit coil 84 is connected to the other end portion of the unit coil 83. The other end portion of the second power receiving coil 81 is connected to the other end portion of the unit coil 84. Note that the number of turns of each of the unit coils 82 to 84 is one.

In addition, the impedance of the power receiving coaxial cable 90 and the power receiving device 40 substantially coincides with the impedance of the power transfer coaxial cable 50 and the power transmitting device 41.

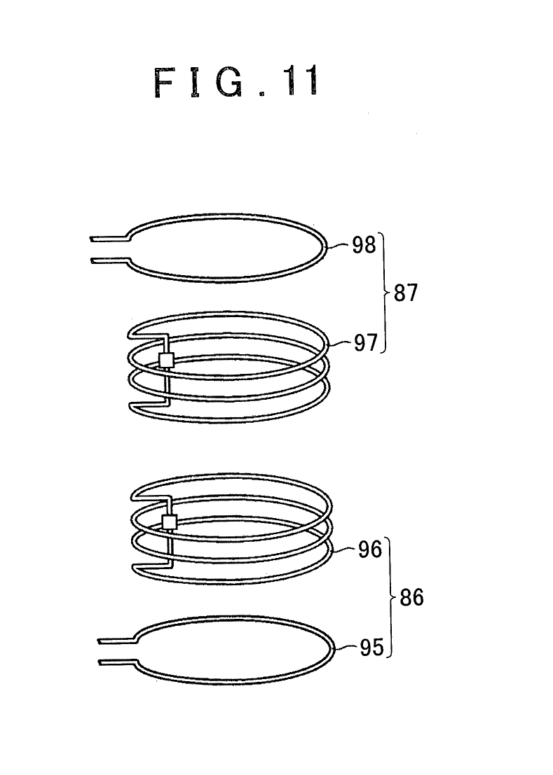

FIG. 11 is a schematic view that schematically shows a power transfer system according to a comparative embodiment. The comparative embodiment shown in FIG. 11 includes a power transmitting device 86 and a power receiving device 87. The power transmitting device 86 includes a coil 95 and a resonator 96. The resonator 96 has the same configuration as the power transmitting portion 28 shown in FIG. 10. The coil 95 is formed in substantially one turn, and supplies electric power from a power supply to the resonator 96 through electromagnetic induction.

The power receiving device 87 includes a resonator 97 and a coil 98. The resonator 97 has the same configuration as the power receiving portion 27 shown in FIG. 10. The coil 98 is formed in substantially one turn, and receives the electric power, received by the resonator 97, through electromagnetic induction.

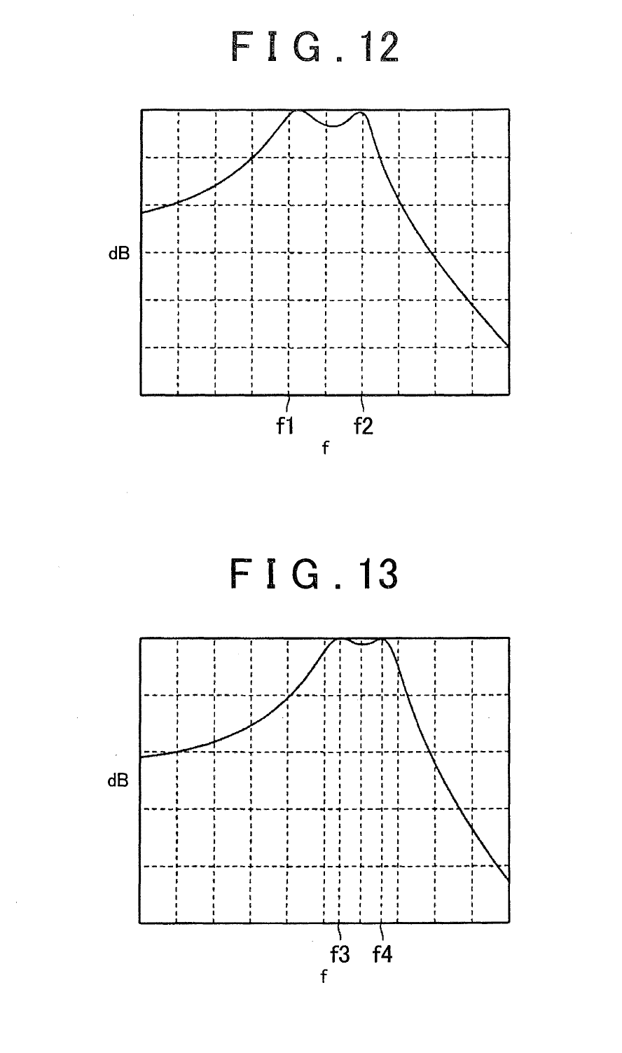

FIG. 12 is a graph that shows a power transfer efficiency in the power transfer system according to the comparative embodiment shown in FIG. 11. FIG. 13 is a graph that shows a power transfer efficiency in the power transfer system shown in FIG. 10.

In FIG. 12 and FIG. 13, the abscissa axis represents the frequency f of electric power supplied. The ordinate axis represents a power transfer efficiency S11 (dB).

As shown in FIG. 12, in the power transfer system according to the comparative embodiment, the power transfer efficiency is maximum at a frequency f1 and a frequency f2. In the power transfer system shown in FIG. 10, the power transfer efficiency is maximum at a frequency f3 and a frequency f4.

Furthermore, the maximum value of the power transfer efficiency of the power transfer system according to the comparative embodiment substantially coincides with the maximum value of the power transfer efficiency of the power transfer system shown in FIG. 10.

Therefore, it appears that the frequency at which the power transfer efficiency becomes a peak is different between the power transfer system shown in FIG. 10 and the power transfer system according to the comparative embodiment.

In other words, as shown in FIG. 10, it appears that, by employing the power transmitting coil unit 23 and the power receiving coil unit 80, it is possible to change the power transmitting-side impedance and the power receiving-side impedance while keeping the peak values of power transfer efficiency.

Furthermore, by employing the power transmitting coil unit 23 and the power receiving coil unit 80, it is possible to suppress radiation of noise from the power receiving coaxial cable 90 and the power transfer coaxial cable 50. Note that, in the present embodiment, the description is made on the case where all the power transmitting resonance coil 24, the second power transmitting coil 61 and the first power transmitting coil 60 are arranged coaxially with one another; however, the first power transmitting coil 60 does not need to be arranged coaxially with the power transmitting device 41 and the second power transmitting coil 61.

For example, in FIG. 9, it is applicable that the second power transmitting coil 61 and the power transmitting resonance coil 24 are arranged coaxially with each other so as to face each other and the first power transmitting coil 60 is arranged laterally to the power transmitting device 41. In this case, the second power transmitting coil 61 and the power transmitting resonance coil 24 are arranged coaxially with each other, so the power transmitting resonance coil 24 and the first power transmitting coil 61 are appropriately coupled through electromagnetic induction. On the other hand, magnetic flux is appropriately supplied from an evanescent field formed around the power transmitting resonance coil 24 to the first power transmitting coil 60. By so doing, the first power transmitting coil 60 is able to appropriately convert unbalanced current, supplied from the alternating-current power supply 21, to balanced current, and to supply the balanced current to the second power transmitting coil 61.

Furthermore, in the present embodiment, the description is made on the example in which coaxial cables are employed in the power transmitting device 41 and the power receiving device 40. Instead of the coaxial cables, parallel lines, strip lines, microstrip lines, or the like, may be employed. Note that, when the rectifier 13 converts balanced current and charges the battery 15, not the power receiving coil unit 12 is employed for the power receiving device 40 but an electromagnetic induction coil may be employed for the power receiving device 40. In this case, instead of the power receiving coaxial cable 150, a twist cable, or the like, may be employed.

The present embodiment is described above; however, the embodiment described above is illustrative and not restrictive in all respects. The scope of the invention is defined by the appended claims. The scope of the invention is intended to encompass all modifications within the scope of the appended claims and equivalents thereof. Furthermore, the above-described numeric values, and the like, are illustrative and not restrictive to the above-described numeric values or ranges.

1. A power transmitting device comprising:
a power transmitting portion that contactlessly transmits electric power to a power receiving portion spaced apart from the power transmitting portion;
a first coil unit that is spaced apart from the power transmitting portion and that supplies electric power to the power transmitting portion; and
a supply cable that is connected to the first coil unit and that supplies electric power from a power supply to the first coil unit, wherein
the first coil unit includes a first coil connected to the supply cable and a second coil connected to the first coil, and
the first coil is arranged around the power transmitting portion, converts unbalanced current, supplied from the power supply, to balanced current and supplies the balanced current to the second coil.

2. The power transmitting device according to claim 1, wherein:
the power transmitting portion includes a power transmitting coil; and
the power transmitting coil and the first coil are arranged so as to face each other.

3. The power transmitting device according to claim 2, wherein:
the power transmitting coil and the second coil are arranged so as to face each other; and
a direction in which current flows through the first coil is different from a direction in which current flows through. the second coil.

4. The power transmitting device according to claim 1, wherein the supply cable includes an inner conductor, an insulator provided so as to cover an outer periphery of the inner conductor, and a grounded outer conductor arranged on the insulator.

5. The power transmitting device according to claim 4, wherein:
the first coil includes a first unit coil, a second unit coil connected to the first unit coil, and a third unit coil connected to the second unit coil;
the second coil includes a first end portion and a second end portion;
the first unit coil includes a third end portion connected to the inner conductor and a fourth end portion connected to the first end portion;
the second unit coil includes a fifth end portion connected to the fourth end portion and a sixth end portion connected to the outer conductor; and
the third unit coil includes a seventh end portion connected to the sixth end portion and an eighth end portion connected to the second end portion.

6. The power transmitting device according to claim 5, wherein the first unit coil, the second unit coil and the third unit coil are arranged coaxially with one another.

7. The power transmitting device according to claim 5, wherein the first unit coil, the second unit coil and the third unit coil have the same shape.

8. The power transmitting device according to claim 1, wherein the power transmitting portion transmits electric power to the power receiving portion through at least one of a magnetic field that is formed between the power receiving portion and the power transmitting portion and that oscillates at a specific frequency and an electric field that is formed between the power receiving portion and the power transmitting portion and that oscillates at the specific frequency.

9. The power transmitting device according to claim 1, wherein a coupling coefficient between the power receiving portion and the power transmitting portion is smaller than or equal to 0.1.

10. The power transmitting device according to claim 1, wherein a difference between a natural frequency of the power transmitting portion and a natural frequency of the power receiving portion is smaller than or equal to 10% of the natural frequency of the power receiving portion.

11. A vehicle comprising:
a power receiving portion that contactlessly receives electric power from a power transmitting portion spaced apart from the power receiving portion;
a second coil unit that, is spaced apart from the power receiving portion and that receives electric power from the power receiving portion;
a power receiving cable that is connected to the second coil unit;
a converter that is connected to the power receiving cable; and
a battery that is connected to the converter, wherein
the second coil unit includes a third coil connected to the power receiving cable and a fourth coil connected to the third coil, and
the third coil is arranged around the power receiving portion, converts balanced current, supplied from the fourth coil, to unbalanced current, and supplies the unbalanced current to the converter.

12. The vehicle according to claim 11, wherein:
the power receiving portion includes a power receiving coil; and
the power receiving coil and the third coil are arranged so as to face each other.

13. The vehicle according to claim 12, wherein:
the power receiving coil and the fourth coil are arranged so as to face each other; and
a direction in which current flows through the third coil is different from a direction in which current flows through the fourth coil.

14. The vehicle according to claim 11, wherein the power receiving cable includes an inner conductor, an insulator provided so as to cover an outer periphery of the inner conductor, and a grounded outer conductor arranged on the insulator.

15. The vehicle according to claim 14, wherein:
the third coil includes a fourth unit coil, a fifth unit coil connected to the fourth unit coil, and a sixth unit coil connected to the fifth unit coil;
the fourth coil includes a ninth end portion and a tenth end portion;
the fourth unit coil includes an eleventh end portion connected to the inner conductor and a twelfth end portion connected to the ninth end portion;
the fifth unit coil includes a thirteenth end portion connected to the twelfth end portion and a fourteenth end portion connected to the outer conductor; and
the sixth unit coil includes a fifteenth end portion connected to the fourteenth end portion and a sixteenth end portion connected to the tenth end portion.

16. The vehicle according to claim 15, wherein the fourth unit coil, the fifth unit coil and the sixth unit coil are arranged coaxially with one another.

17. The vehicle according to claim 15, wherein the fourth unit coil, the fifth unit coil and the sixth unit coil have the same shape.

18. The vehicle according to claim 11, wherein the power receiving portion receives electric power from the power transmitting portion through at least one of a magnetic field that is formed between the power receiving portion and the power transmitting portion and that oscillates at a specific frequency and an electric field that is formed between the power receiving portion and the power transmitting portion and that oscillates at the specific frequency.

19. The vehicle according to claim 11, wherein a coupling coefficient between the power receiving portion and the power transmitting portion is smaller than or equal to 0.1.

20. The vehicle according to claim 11, wherein a difference between a natural frequency of the power transmitting portion and a natural frequency of the power receiving portion is smaller than or equal to 10% of the natural frequency of the power receiving portion.

21. A power transfer system comprising:
a vehicle that includes a power receiving portion; and
a power transmitting device that includes a power transmitting portion that contactlessly transmits electric power to the power receiving portion, a first coil unit that is spaced apart from the power transmitting portion and that supplies electric power to the power transmitting portion, and a supply cable that is connected to the first coil unit and that supplies electric power from a power supply to the first coil unit, wherein
the first coil unit includes a first coil connected to the supply cable and a second coil connected to the first coil, and
the first coil is arranged around the power transmitting portion, converts unbalanced current, supplied from the power supply, to balanced current and supplies the balanced current to the second coil.

22. A power transfer system comprising:
a power transmitting device that includes a power transmitting portion; and
a vehicle that includes a power receiving portion that contactlessly receives electric power from the power transmitting portion, a second coil unit that is spaced apart from the power receiving portion and that receives electric power from the power receiving portion, a power receiving cable that is connected to the second coil unit, a converter that is connected to the power receiving cable, and a battery that is connected to the converter, wherein
the second coil unit includes a third coil connected to the power receiving cable and a fourth coil connected to the third, coil, and
the third coil is arranged around the power receiving portion, converts balanced current, supplied from the fourth coil, to unbalanced current, and supplies the unbalanced current to the converter.
